(19) United States
(12) Patent Application Publication
(10) Pub. No.: US 2013/0121174 A1
(43) Pub. Date: May 16, 2013

(54) Methods and Apparatus for Managing Network Signaling

(71) Applicant: Tommi T. Koivisto, Espoo (FI)

(72) Inventor: Tommi T. Koivisto, Espoo (FI)

(73) Assignee: Renesas Mobile Corporation

(21) Appl. No.: 13/297,508

(22) Filed: Nov. 16, 2011

(30) Foreign Application Priority Data
Nov. 14, 2011 (GB) GB1119619.3

(51) Int. Cl. H04W 72/04; H04W 24/00

(52) U.S. Cl. 370/252; 370/329

(57) ABSTRACT

Systems and apparatus for managing signaling of channel state information. A user equipment performs channel state information measurements in measurement subframes. The user equipment receives an uplink triggering grant from a base station, with the uplink triggering grant specifying a measurement subframe for which channel state information is to be reported. The channel state information triggering uplink grant specifies a measurement subframe at least a designated number of subframes back from an uplink communication subframe in which the channel state information is to be reported. At the uplink communication subframe corresponding to the channel state information triggering uplink grant, the user equipment reports the channel state information measured at the specified measurement subframe.

### PRIORITY

This application claims priority under 35 U.S.C. 119(a) to “Methods and Apparatus for Managing Network Signaling,” UK Patent Application No. 1119619.3, filed on 14 Nov. 2011 and incorporated herein by reference in its entirety.

### TECHNICAL FIELD

The exemplary and non-limiting embodiments of this invention relate generally to wireless communication systems, methods, devices and computer programs, and more specifically relate to mechanisms for processing channel state information (CSI) feedback.

### BACKGROUND

The following abbreviations that may be found in the specification and/or the drawing figures are defined as follows:

CDMA code division multiple access

CQI Channel Quality Indication

CSI Channel State Information

CSI-RS Channel State Information Reference Signal

DL Downlink

eNodeB evolved Node B

eNB evolved Node B

HARQ Hybrid ARQ

HSS home subscription server

LTE long term evolution

MTC Machine-Type Communications

PDCCH Physical Downlink Control Channel

PDSCH Physical Downlink Shared Channel

PLMN public land mobile network

PMI Precoding Matrix Indicator

PUCCH Physical Uplink Control Channel

PUSCH Physical Uplink Shared Channel

RA random access

RRC Radio Resource Control

UE user equipment

UL Uplink

The demand for communication services has grown at an increasingly rapid rate in recent years, and this trend is expected to continue. Meeting the increases in demand will be achieved in substantial part by increases in the efficiency with which information can be communicated. The costs of deploying communications infrastructure are substantial, and much of the increase in demand comes not from an increase in the number of users to be served, but from increasing demand from the same users for more and better services. Users may demand services that require a doubling or tripling of communication capacity. These same users will not be willing to pay doubled or tripled subscription rates to obtain this increased capacity. One mechanism for maintaining a high level of efficiency is the use of multi-input-multi-output (MIMO) features, and the use of increased numbers of transmit and receive antennas for MIMO carries many advantages. For example, the use of increased numbers of antennas enhances support of multi-user MIMO and also improves the ability to perform seamless switching between single and multiuser operation. One mechanism for supporting MEMO is the use of channel state information (CSI) feedback. One mechanism for the delivery of channel state information is the use of channel state information reference signals (CSI-RS), which are intended for channel state information feedback from a user equipment (UE) to an evolved node B (eNB). CSI-RS signals are transmitted periodically and have a very low overhead. In addition, high reuse factors are possible, particularly for a small number of transmit antennas. Channel state information is reported by a UE to an eNB either periodically, or aperiodically based on triggering signaling from the eNB to the UE.

### SUMMARY

The foregoing and other problems are overcome, and other advantages are realized, by the use of exemplary embodiments of this invention.

In a first embodiment of the invention, an apparatus comprises at least one processor and at least one memory storing a computer program. The at least one memory with the computer program is configured with the at least one processor to cause the apparatus to perform actions comprising at least performing channel state information measurements in each of one or more measurement subframes. The measurement subframes are specified based on a configuration of the apparatus. The actions further comprise receiving a channel state information triggering uplink grant designating a measurement subframe for which measurement information is to be reported. The designated measurement subframe lies at least a specified number of subframes before an uplink communication subframe in which the measurement information is to be reported. The actions further comprise transmitting a communication state information report signal in response to the channel state information triggering uplink grant.

According to another embodiment of the invention, an apparatus, comprises at least one processor and at least one memory storing a computer program. The at least one memory is configured, with the computer program and the at least one processor, to cause the apparatus to perform actions comprising at least sending a channel state information triggering uplink grant designating a measurement subframe for which measurement information is to be reported by a user equipment receiving the channel state information triggering uplink grant. The designated measurement subframe lies at least a specified number of subframes before an uplink communication subframe in which the measurement information is to be reported.

According to another embodiment of the invention, a method comprises sending a channel state information triggering uplink grant designating a measurement subframe for which measurement information is to be reported by a user equipment receiving the channel state information triggering uplink grant. The designated measurement subframe lies at least a specified number of subframes before an uplink communication subframe in which the measurement information is to be reported.

According to another embodiment of the invention, a non-transitory computer readable storage medium stores a program of instructions. Execution of the program of instructions by a processor configures an apparatus to perform actions comprising at least performing channel state information measurements in each of one or more measurement subframes. The measurement subframes are specified based on a configuration of the apparatus. The actions further comprise receiving a channel state information triggering uplink grant designating a measurement subframe for which measurement information is to be reported. The designated measurement subframe lies at least a specified number of subframes before an uplink communication subframe in which the measurement information is to be reported. The actions further comprise transmitting a communication state information report signal in response to the channel state information triggering uplink grant.

These and other embodiments and aspects are detailed below with particularity.

### BRIEF DESCRIPTION OF THE DRAWINGS

FIG. 1 illustrates a cell of a wireless network in which embodiments of the present invention may be implemented;

FIG. 2 illustrates a pattern of subframes showing measurement and signaling according to an embodiment of the present invention;

FIG. 3 illustrates a pattern of subframes showing measurement and signaling according to an embodiment of the present invention; and

FIG. 4 illustrates a process according to an embodiment of the present invention.

### DETAILED DESCRIPTION

Embodiments of the present invention recognize that two mechanisms are currently in use for directing a UE to report channel state information to an eNB. One of these mechanisms is periodic reporting on a physical uplink control channel (PUCCH). In this case, the UE is semi-statically configured with a reporting period in subframes as well as a subframe offset. The UE is thus reporting in pre-allocated resources at pre-defined time instants. 3GPP TS 36.213 specifies that the subframe to which the reported CSI corresponds is subframe n−4 when the CSI is reported in uplink subframe n. In other words, the UE is allotted a time of 4 ms to process the CSI measurements and compute the feedback before having to transmit the report in uplink.

Another mechanism is periodic reporting on the physical uplink shared channel (PUSCH). In this case, the UE receives an uplink grant on the physical downlink control channel (PDCCH). This uplink grant both allocates the uplink resources on which the UE should transmit the report, and gives an indication, occupying one or two bits, that CSI feedback is requested. This uplink grant is matched with the hybrid automatic repeat request (HARQ) cycle, so that, similarly to the periodic procedure, for an uplink grant transmitted in subframe n−4, the report will be transmitted in subframe n, allowing 4 ms of processing time. The CSI measurement subframe is the same as the subframe in which the CSI triggering uplink grant is transmitted in downlink.

As the number of transmit and receive antennas increases, the complexity of analyzing the channel state information and producing a CSI report increases. Typically, a UE would need to find an appropriate transmission rank and a precoding matrix indicator (PMI) for that rank. In addition, the UE needs to compute channel quality information (CQI) corresponding to the chosen PMIs. Finally, the UE may need to report all of this information, other than rank, for each frequency subband, so that the computational burden is proportional to the number of subbands, which may be substantial. Feedback is typically computed and transmitted based on a codebook, and as the codebook specified by standards governing communication takes on a finer granularity, the computational burden will increase accordingly. The use of a finer granularity codebook carries substantial advantages, allowing for targeting at more accurate feedback for the spatial properties of the radio channel, so that finer and finer granularities may be expected to be required as standards continue to develop.

In addition, some applications may further increase the complexity of the channel state information that must be reported. For example, in the case of coordinated multi-point processing (COMP) a UE may need to report CSI feedback for multiple cells or multiple transmit points. Any enhancement of such a nature substantially increases the computational burden borne by the UE.

As the complexity of the CSI computation and reporting task increases, performing the needed computation and reporting becomes more and more difficult. The difficulty is particularly increased in the case of aperiodic reporting, because the UE performs the computation when it receives a CSI trigger, and the UE does not know beforehand when the eNB will send the CSI triggers.

A number of problems attend various mechanisms for extending the time available for CSI computation and reporting that might suggest themselves. The expected continued increase in processing capacity of user devices may not solve the problem. Manufacturers wish to provide users with ever smaller and less expensive devices. They also wish to provide users with devices that exhibit low power consumption, in order to extend battery life.

One mechanism that might appear to suggest itself is to define specifications so that the CSI report corresponds to a measurement performed in subframe n−x, where x>4. Such a definition extends the number of subframes between the time the measurement is taken and the time it needs to be reported, and thus extends the time available to the UE for processing. In the case of aperiodic reporting, such a procedure would violate the rule that the uplink grant with the CSI trigger always determines the measurement subframe, that is, that the uplink grant with the CSI trigger are the same subframe. The UE has no information to as to when the eNB will send CSI triggers, so that the UE would need to take a measurement in each subframe in order to be ready for CSI triggering. Moving the CSI triggering uplink grant to a subframe out beyond n−4 would disrupt the well-defined HARQ cycles and thus require significant changes to LTE specifications.

Embodiments of the present invention therefore provide for mechanisms to signal to the UE separately (from the reporting trigger) the subframes in which the UE should do the corresponding CSI measurements.

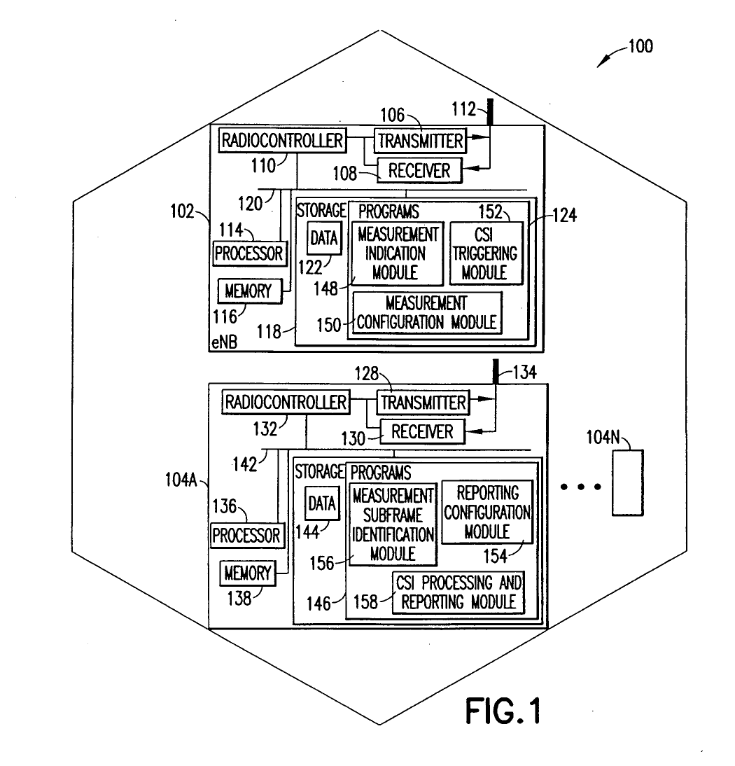

FIG. 1 illustrates a cell 100 representing a portion of a geographic area served by a cellular communications network. The cell 100 is served by a base station, which in the present exemplary embodiment is an eNodeB 102. Various devices served by the eNodeB 102 operate within the cell 100, including various UEs 104A, . . . , 104N.

The eNB 102 may suitably include a transmitter 106, receiver 108, radiocontroller 110, and antenna 112. The eNB 102 may also include a processor 114, memory 116, and storage 118, communicating with one another and with the radiocontroller 110 over a bus 120. The eNB 102 may also store data 122 and programs 124, residing in storage 118.

The UE 104A may suitably include a transmitter 128, receiver 130, radiocontroller 132, and antenna 134. The UE 104A may also include a processor 136, memory 138, and storage 140, communicating with one another and with the radiocontroller 132 over a bus 142. The UE 104A may also store data 144 and programs 146, residing in storage 140.

The UE 104A and other UEs suitably provide for improved efficiency by reporting channel state information to the eNB 102. In various embodiments of the invention, reporting may be accomplished using aperiodic reporting over a physical uplink shared channel (PUSCH). The eNB 102 sends information to a UE such as the UE 104A to configure the UE with measurement subframes. In one embodiment of the invention, the configuration may be accomplished subframe by subframe. For example, the programs 124 may include a measurement indication module 148, which produces a measurement request that may be included in a downlink or uplink grant. To take another example, the programs 124 may include a measurement configuration module 150, which sends configuration information to a UE through radio resource control (RRC) configuration. Configuration of the UE through signaling of measurement subframes or through RRC configuration of measurement subframes is discussed in additional detail below.

The programs 124 may further include a CSI triggering module 152. When the eNB 102 is to receive a CSI report, the CSI triggering module directs the sending of a CSI triggering uplink grant to the UE. If the grant is sent to the UE in subframe n−4, the CSI report will be received from the UE in subframe n. The report will correspond to the latest configured measurement subframe before subframe n−x, where x is the defined processing time in subframes. The configuration of measurement subframes therefore provides the UE with a minimum processing time of x subframes, but allows variation in the processing time because the configured measurement subframe is not defined as the n−xth subframe, but instead is the latest subframe before the n−xth subframe. The configuration therefore allows for considerable variation in the number of subframes between the measurement and the reporting, and the UE does not need to take excessive measurements in order to meet a requirement that the measurement be taken a specific number of subframes before an event that cannot be anticipated.

In another embodiment of the invention, the eNB 102 configures a UE such as the UE 104A with periodic reporting instants, which may be PUCCH or PUSCH reporting instants, defined through RRC configuration, suitably accomplished under the control of a reporting configuration module 154. A UE so configured will report in subframe n only if a CSI trigger is received in subframe n−4 and if subframe n is a reporting instant. The UE can perform measurements x subframes before each reporting subframe, where x>4, allowing an assurance that the UE will receive an interval of at least x between a measurement and a report.

Suppose now that the UE 104A receives a measurement subframe identification. Such an indication may result from explicit signaling or from recognition of a measurement subframe, such as an explicitly configured measurement subframe or a subframe a specified number of subframes preceding a configured reporting subframe. Recognition may be accomplished based on a measurement subframe pattern or a reporting subframe pattern, suitably stored as part of the data 144.

Identification may suitably be accomplished under the control of a measurement subframe identification module 156, which may suitably be one of the programs 146 residing in storage 140, and which may be transferred to memory 138 as needed for execution by the processor 136.

Upon receiving the measurement subframe identification, the UE 104A begins channel state information processing, suitably under the control of a CSI processing and reporting module 158, in order to generate CSI feedback. The CSI feedback may suitably comprise any LTE feedback mode, such as wideband/subband PMI and wideband/subband CQI(s), rank, or any other suitable feedback mode.

In another embodiment of the invention, the CSI measurement subframes may be linked with CSI-RS subframes. CSI-RS are transmitted only periodically a UE configured to use CSI-RS is typically able to perform CSI measurement in CSI-RS subframes. In this case a UE such as the UE 104A would be configured to report channel state information based on the latest CSI-RS subframe received before subframe n−x, where subframe n, is the uplink communication subframe in which reporting is to be carried out and x is a specified number of subframes before the subframe n.

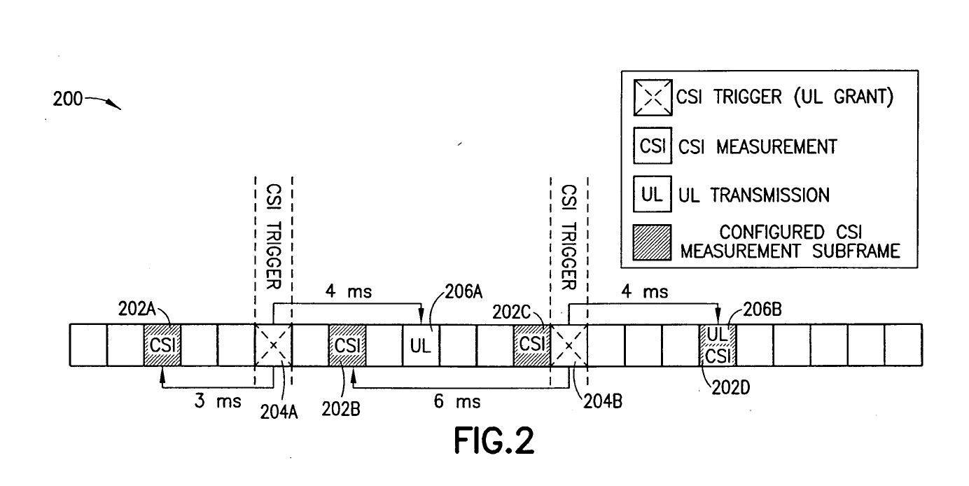

FIG. 2 illustrates an exemplary subframe pattern 200, showing measurement and reporting procedures according to an embodiment of the present invention. The subframe pattern 200 comprises measurement subframes 202A-202D, CSI triggering frames 204A and 204B, and uplink transmission frames 206A and 206B. The CSI triggering frames 204 and 204B designate a measurement frame for which information is to be reported. The reporting called for by the CSI triggering frames 204A and 204B is performed at uplink transmission frames 206A and 206B, respectively. One of the subframes is designated both as a measurement subframe and an uplink transmission subframe, and this subframe is designated both as subframe 202D and 206B for convenience.

Each of the CSI triggering subframes 204A and 204B designates a measurement subframe that precedes the corresponding uplink transmission subframe by a designated number x of subframes. In the present example, the number x of subframes is chosen to be 6, so that if each subframe occupies 1 ms, at least 6 ms of processing time is available including the 4 ms from the CSI triggering uplink grant to the transmission of the report in the uplink communication subframe. The UL grant with the CSI trigger always refers to the previously configured CSI measurement subframe. For example, in the case of the CSI triggering subframe 204A, the corresponding measurement subframe 202A was received 3 ms before the CSI triggering subframe 204A. In the case of the CSI triggering subframe 204B, the corresponding measurement subframe 202B was received 6 ms before the CSI triggering subframe 204B.

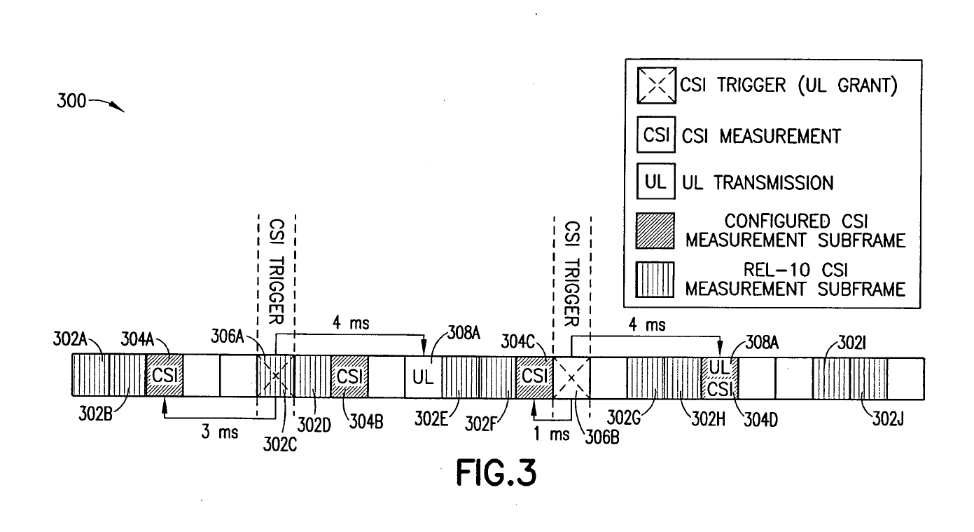

FIG. 3 illustrates a subframe pattern 300 according to another embodiment of the present invention. The subframe pattern 300 corresponds to an operation under 3GPP release 10 in which measurements are allowed only in a specified subset of subframes. In 3GPP release 10 as currently envisioned, measurements are conducted in the same subframe in which the CSI uplink grant is triggered. In the example illustrated here, the pattern 300 includes 3GPP Release 10 measurement subframes 302A-302J, as well as measurement subframes 304A-304D, CSI triggering subframes 306A and 306B, and CSI uplink communication subframes 308A and 308B. The CSI triggering subframes 306A and 306B refer to measurements at least subframes before the uplink grant.

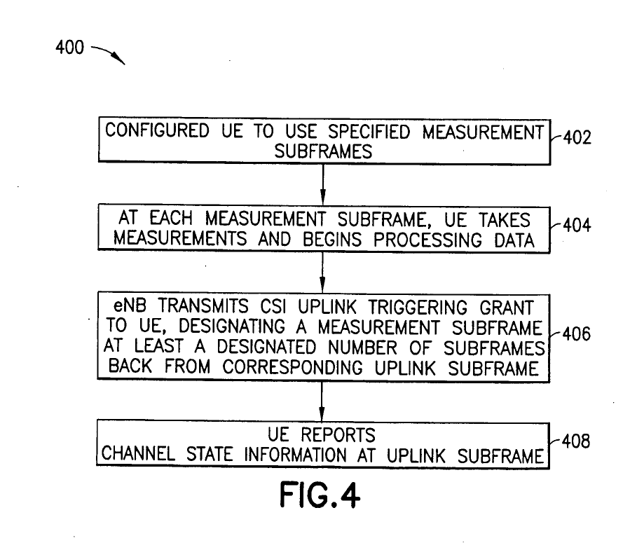

FIG. 4 illustrates a process 400 according to an embodiment of the present invention. At step 402, a UE is configured to use specified measurement subframes. At step 404, at each measurement subframe, the UE takes measurements and begins processing the data. At step 406, an eNB transmits a CSI triggering uplink grant to the UE, with the uplink grant designating a measurement subframe that is at least a specified number of subframes back from the uplink communication subframe in which the measurement information will be communicated. At step 408, the UE transmits information for the designated measurement subframe, suitably in the form of a channel state information reference signal.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1. An apparatus, comprising:
at least one processor; and
at least one memory storing a program of instructions;
wherein the program of instructions is configured, with the at least one memory and the at least one processor to cause the apparatus to perform actions comprising at least:
performing channel state information measurements in each of one or more measurement subframes, wherein the measurement subframes are specified based on a configuration of the apparatus;
receiving a channel state information triggering uplink grant designating a measurement subframe for which measurement information is to be reported, wherein the designated measurement subframe lies at least a specified number of subframes before an uplink communication subframe in which the measurement information is to be reported; and
transmitting a communication state information report signal in response to the channel state information triggering uplink grant.

2. The apparatus of claim 1, wherein the specified number of subframes is greater than 4.

3. The apparatus of claim 1, wherein the configuration of the apparatus is performed based on receiving signaling from a base station directing the apparatus to designate specified subframes as measurement subframes.

4. The apparatus of claim 3, wherein the signaling comprises a measurement trigger transmitted by the base station in at least one of an uplink and a downlink grant.

5. The apparatus of claim 3, wherein the configuration of the apparatus defines a pattern of measurement subframes.

6. The apparatus of claim 5, wherein the pattern of measurement subframes is received using radio resource control signaling.

7. An apparatus, comprising:
at least one processor; and
at least one memory storing a program of instructions;
wherein program of instructions is configured, with the at least one memory and the at least one processor to cause the apparatus to perform actions comprising at least:
sending a channel state information triggering uplink grant designating a measurement subframe for which measurement information is to be reported by a user equipment, wherein the designated measurement subframe lies at least a specified number of subframes before an uplink communication subframe in which the measurement information is to be reported.

8. The apparatus of claim 7, wherein the functions further comprise specifying measurement subframes during which measurements are to be performed by the user equipment.

9. The apparatus of claim, wherein specifying measurement subframes comprises signaling the user equipment to identify one or more measurement subframes.

10. The apparatus of claim 7, wherein at least one measurement subframe is specified by a measurement trigger transmitted in one of an uplink and a downlink grant.

11. The apparatus of claim 8, wherein specifying measurement subframes comprises specifying a pattern of measurement subframes using radio resource signaling.

12. The apparatus of claim 7, wherein the functions further comprise specifying reporting instants for the user equipment, wherein a reporting instant comprises a subframe in which the user equipment is directed to perform uplink reporting of channel state information.

13. A method comprising:
sending a channel state information triggering uplink grant designating a measurement subframe for which measurement information is to be reported by a user equipment wherein the designated measurement subframe lies at least a specified number of subframes before an uplink communication subframe in which the measurement information is to be reported.

14. The method of claim 13, further comprising specifying measurement subframes during which measurements are to be performed by the user equipment.

15. The method of claim 13, wherein at least one measurement subframe is specified by a measurement trigger transmitted in one of an uplink and a downlink grant.

16. The method of claim 14, wherein specifying measurement subframes comprises specifying a pattern of measurement subframes using radio resource signaling.

17. The method of claim 13, wherein the functions further comprise specifying reporting instants for the user equipment, wherein a reporting instant comprises a subframe in which the user equipment is directed to perform uplink reporting of channel state information.

18. A non-transitory computer readable storage medium storing a program of instructions, execution of which by a processor configures an apparatus to perform actions comprising at least:
performing channel state information measurements in each of one or more measurement subframes, wherein the measurement subframes are specified based on a configuration of the apparatus;
receiving a channel state information triggering uplink grant designating a measurement subframe for which measurement information is to be reported, wherein the designated measurement subframe lies at least a specified number of subframes before an uplink communication subframe in which the measurement information is to be reported; and
transmitting a communication state information report signal in response to the channel state information triggering uplink grant.

19. The computer readable storage medium of claim 18, wherein the configuration of the apparatus is performed based on signaling by a base station directing the apparatus to designate specified subframes as measurement subframes.

20. The computer readable storage medium of claim 18, wherein the signaling comprises a measurement trigger transmitted by the base station in at least one of an uplink and a downlink grant.

21. The computer readable storage medium of claim 18, wherein the configuration of the apparatus defines a pattern of measurement subframes.

22. The computer readable storage medium of claim 21, wherein the pattern of measurement subframes is received using radio resource control signaling.
